(19) United States
(12) Patent Application Publication
(10) Pub. No.: US 2014/0365241 A1
(43) Pub. Date: Dec. 11, 2014

(54) SYSTEM FOR PRE-HOSPITAL PATIENT INFORMATION EXCHANGE AND METHODS OF USING SAME

(71) Applicant: ESO Solutions, Inc., Austin, TX (US)

(72) Inventors: Christopher Thomas Dillie, Austin, TX (US); Richard Spencer Hale, Austin, TX (US)

(21) Appl. No.: 14/182,009

(22) Filed: Feb. 17, 2014

Related U.S. Application Data
(60) Provisional application No. 61/831,468, filed on Jun. 5, 2013.

(51) Int. Cl. G06F 19/00

(52) U.S. Cl. CPC G06F 19/322
USPC 705/3

(57) ABSTRACT

Disclosed is a system and method for a platform as a service solution stack for real-time, bi-directional dynamic routing of vendor agnostic pre-hospital electronic records to/from a health care provider. The solution provides a single interaction point for all customers or nodes on the enhanced network, which allows a customer to integrate with the platform a single time regardless of the number of network interactions with other customers.

### CROSS-REFERENCE TO RELATED APPLICATIONS

This application claims the benefit of priority from U.S. Provisional Patent Application No. 61/831,468, filed Jun. 5, 2013, entitled “System for Pre-Hospital Patient Information Exchange and Methods of Using Same,” which is incorporated herein by reference.

This application includes material that is subject to copyright protection. The copyright owner has no objection to the facsimile reproduction by anyone of the patent disclosure, as it appears in the Patent and Trademark Office files or records, but otherwise reserves all copyright rights whatsoever.

### TECHNICAL FIELD

The present disclosure relates in general to the field of electronically obtaining and exchanging pre-hospital patient information. In particular, the system provides for electronic patient health records to be input and made available to both pre-hospital service providers and health providers. The disclosed systems and methods support a wide variety of scenarios and includes various products and services.

### STATEMENT OF FEDERALLY FUNDED RESEARCH

None.

### BACKGROUND OF THE DISCLOSURE

When patients are seen in the pre-hospital environment the patient encounter is documented as required by law. This medical/legal record contains information about the present encounter as well as general information about the patient. Some of the information contained within the medical/legal record includes: incident response information, incident location, transport information, incident times, patient demographic, injury categorization, physician, living will, insurance information, patient medication history, medications and known allergies. Further, the patient's vital signs are recorded to include blood pressure, respiratory rate, pulse, electrocardiogram (ECG), blood glucose, temperature and other relevant clinical findings. All treatments provided to the patient are then captured within the record. Findings from the physical assessment of the patient are contained within the medical/legal record. The clinical impression of the person responsible for care is documented along with any pertinent signs and symptoms. A narrative describing the overall incident and any relevant background is contained within the record. In most cases the patient care record used in the pre-hospital environment is capable of collecting over 700 data elements related to the patient encounter.

While most states require electronic communication of this data to their state repositories, the communication between the pre-hospital environment and the rest of healthcare is primarily provided via printed documents. This manual, paper-based process increases the chance of human error and the risk of unauthorized disclosure of protected health information (PHI) for both the pre-hospital provider and healthcare entity receiving the patient. Additionally, because there is often a delay in transfer of this information, the clinical staff at the receiving facility may not have access to critical assessment and treatment information found in the pre-hospital patient care record. There are currently no other standard solutions in the market that provide this exchange of data between the pre-hospital environment and healthcare community.

### SUMMARY OF THE DISCLOSURE

The present disclosure addresses failings in the art by providing a system and method for addressing pre-hospital data capture and exchange. The present disclosure enables any compliant pre-hospital software package to connect to any compliant electronic medical records system. Such systems can include, but are not limited to, electronic medical records (EMR), electronic health records (EHR) and/or hospital information exchange (HIE) system, and all other known or to be known records systems. The system provides both dynamic routing across the self service network and stream transformation of content into communication protocols understood by either side. That is, the present disclosure applies a platform as a service to resolves two significant gaps in the information exchange process between Emergency Medical Service (EMS) agencies and related pre-hospital service providers and emergency departments: the present disclosure automates the transfer of electronic records of patients to receiving facilities, providing both discreet data and digital images of the pre-hospital patient care record; and the present disclosure automates the return of patient outcome, patient demographic and other relevant patient information back to pre-hospital care providers from the receiving facility.

Patient information returned from the receiving facility will typically contain information about the patient's diagnosis, assessment finding at the hospital, patient demographic and billing information as well as any other data that could be used in a comprehensive QA/QI program. This data enables the pre-hospital agency to quantify the quality of care they provide. Without this information it is impossible for the pre-hospital provider to know whether the care they provided was medically appropriate. The shared data is used to improve the continuum of care by providing access to the electronic patient care records (ePCR), EMR and/or EHR, and the like, across multiple networks and platforms. It provides raw data that allows hospitals and others to look at a broader view of patient information starting from the time they called for help rather than the door time at the emergency room (ER). It can be used to automate submission of data from the pre-hospital record required for registries such as trauma, cardiac, stroke, etc.

In return for providing information about a patient's care prior to arrival at an emergency department or hospital the EMS provider would like to receive information about how the patient progressed through his shared encounter with the EMS provider and his hospital stay. The data set has been designed to improve pre-hospital patient care through closed loop feedback of patient outcomes post encounter as part of an EMS agency's QA/QI process improvement as a well as improve billing processes through improved payer demographics.

The present disclosure may further act as a concentrator and provider of that information from pre-hospital encounters into a data format that can be consumed and utilized by the greater healthcare community.

The present disclosure enables information from pre-hospital encounters to be transmitted by computer-implemented means. The present disclosure will enable information to be exchanged via computer networks, such as, but not limited to, Wide Area Networks (WAN) or macro networks, such as UMTS, GSM, GPRS, long-term evolution (LTE) or Wimax networks, to WiFi networks.

Generally, the present disclosure provides for systems and methods for a health data exchange (HDE) system where medical information, which is stored in different formats, can be exchanged between different entities within the scope of providing care to patients. The disclosed systems and methods provide channels for the flow of information and patient records across different health care entities that may store, generate, require or facilitate such patient records. The HDE's ability to receive, retrieve and process patient data requests from various entities, along with the transformation of such data from the storing format to the annotations of such data, enable a flexible and extendable health data exchange system. It should be understood that references to a health data exchange and healthcare data exchange are interchangeable references to similar systems, as discussed herein.

Indeed, the present disclosure improves the utilization of pre-hospital information and exchange. The preferred embodiments of the disclosure realize an instance of an emergency medical responder's treatments have utility when incorporated into the emergency or hospital treatment, thus allowing for maintenance of the pre-hospital information for the purposes of providing treatment, as well as data and feedback for the emergency responders, as discussed in more detail below.

In accordance with one or more embodiments, a method is disclosed for electronically obtaining and exchanging pre-hospital patient information. According to embodiments discussed herein, the disclosed methods provide for electronic patient health records to be input and made available to both pre-hospital service providers and healthcare providers. The disclosed methods discussed herein provide for a continuum of care among entities, companies and the like during the course of patient care.

In accordance with one or more embodiments, a non-transitory computer-readable storage medium is provided, the computer-readable storage medium tangibly storing thereon, or having tangibly encoded thereon, computer readable instructions that when executed cause at least one processor to perform a method for providing electronic patient health records to be input and made available to both pre-hospital service providers and healthcare providers.

In accordance with one or more embodiments, a system is provided that comprises one or more computing devices configured to provide functionality in accordance with such embodiments. In accordance with one or more embodiments, functionality is embodied in steps of a method performed by at least one computing device. In accordance with one or more embodiments, program code to implement functionality in accordance with one or more such embodiments is embodied in, by and/or on a computer-readable medium.

### BRIEF DESCRIPTION OF THE DRAWINGS

The foregoing and other objects, features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 depicts a network environment for a health data exchange system in accordance with some embodiments of the present disclosure;

FIG. 2 depicts an network environment for a health data exchange system in connection with the system described in FIG. 1, in accordance with some embodiments of the present disclosure;

FIG. 3A illustrates a preferred HDE platform in accordance with some embodiments of the present disclosure;

FIG. 3B is a block diagram illustrating an HDE engine for performing system and methods of embodiments of the present disclosure;

FIGS. 4A-4B are block diagrams illustrating processes for implementing the HDE platform discussed herein in accordance with some embodiments of the present disclosure; and

FIG. 5 is a block diagram illustrating architecture of a hardware device in accordance with one or more embodiments of the present disclosure.

### DETAILED DESCRIPTION OF THE DISCLOSURE

While the making and using of various embodiments of the present disclosure are discussed in detail below, it should be appreciated that the present disclosure provides many applicable inventive concepts that can be embodied in a wide variety of specific contexts, goods, or services. The specific embodiments discussed herein are merely illustrative of specific ways to make and use the disclosure and do not delimit the scope of the disclosure.

All publications and patent applications mentioned in the specification are indicative of the level of skill of those skilled in the art to which this disclosure pertains. All publications and patent applications are herein incorporated by reference to the same extent as if each individual publication or patent application was specifically and individually indicated to be incorporated by reference.

The present disclosure will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer, special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

These computer program instructions can be provided to a processor of a general purpose computer, special purpose computer, ASIC, or other programmable data processing apparatus, such that the instructions, which execute via the processor of the computer or other programmable data processing apparatus, implement the functions/acts specified in the block diagrams or operational block or blocks.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

For the purposes of this disclosure a computer readable medium (or computer-readable storage medium/media) stores computer data, which data can include computer program code (or computer-executable instructions) that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further include a system of terminals, gateways, routers, or the like coupled by wireless radio links, or the like, which may move freely, randomly or organize themselves arbitrarily, such that network topology may change, at times even rapidly. A wireless network may further employ a plurality of network access technologies, including Long Term Evolution (LTE), WLAN, Wireless Router (WR) mesh, or 2nd, 3rd, or 4th generation (2G, 3G, or 4G) cellular technology, or the like. Network access technologies may enable wide area coverage for devices, such as client devices with varying degrees of mobility, for example.

For example, a network may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), North American/CEPT frequencies, radio frequencies, single sideband, radiotelegraphy, radioteletype (RTTY), Bluetooth, 802.11b/g/n, or the like. A wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

For purposes of this disclosure, a client (or consumer or user) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device an Near Field Communication (NFC) device, a Personal Digital Assistant (PDA), a handheld computer, a tablet computer, a laptop computer, a set top box, a wearable computer, an integrated device combining various features, such as features of the forgoing devices, or the like.

A client device may vary in terms of capabilities or features. Claimed subject matter is intended to cover a wide range of potential variations. For example, a mobile device may include a numeric keypad or a display of limited functionality, such as a monochrome liquid crystal display (LCD) for displaying text. In contrast, however, as another example, a web-enabled client device may include one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

A client device may include or may execute a variety of operating systems, including a personal computer operating system, such as a Windows, iOS or Linux, or a mobile operating system, such as iOS, Android, or Windows Mobile, or the like. A client device may include or may execute a variety of possible applications, such as a client software application enabling communication with other devices, such as communicating one or more messages. The client device, mobile device, or wireless communication device, in accordance with the disclosure may be a portable or mobile telephone, a Personal Digital Assistant (PDA), a wireless video or multimedia device, a portable computer, an embedded communication processor or similar wireless communication device. In the following description, the communication device will be referred to generally as User Equipment (UE) for illustrative purposes and it is not intended to limit the disclosure to any particular type of communication device. Certain modern handheld electronic devices (UE) comprise the necessary components to connect to a cellular network, such as a 2G, 2.5G, 3G, and/or LTE network, and the necessary components to connect to a non-cellular IP Connectivity Access Network (IP CAN) such as a wireless LAN network (e.g. IEEE 802.11a/b/g/n) or a wired LAN network (e.g. IEEE 802.3).

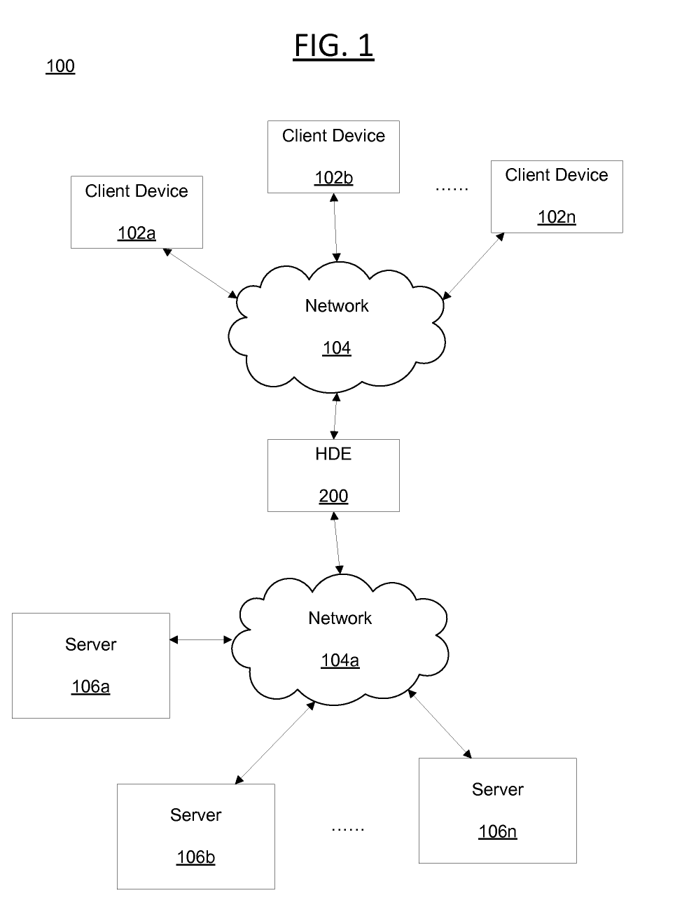

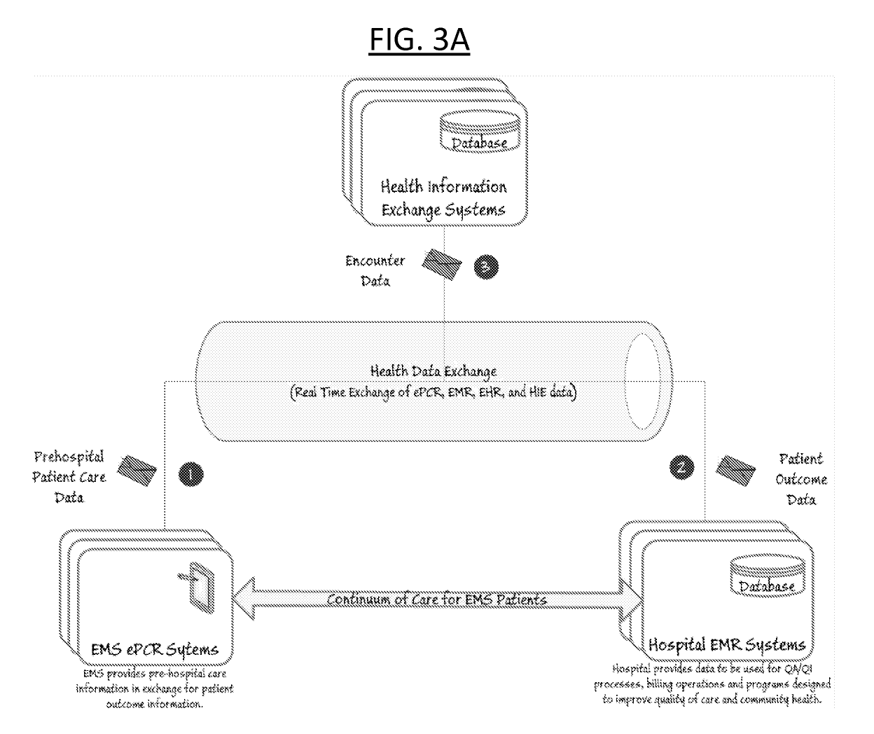

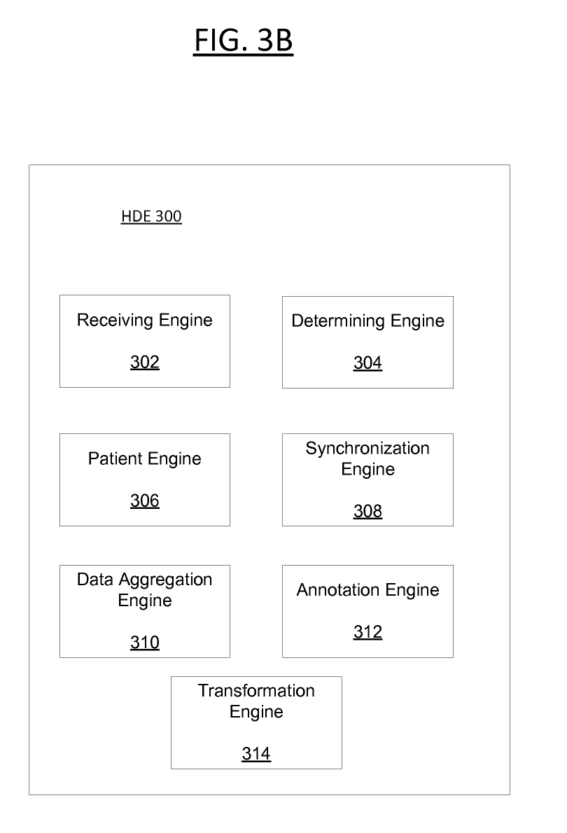

The principles discussed herein may be embodied in many different forms. The preferred embodiments of the present disclosure will now be described where for completeness, reference should be made at least to FIGS. 1-5. FIG. 1 depicts a network computing environment 100 in accordance with some embodiments of the present disclosure. The network environment comprises one or more client devices 102a-102n (also referred to as local machine(s) 102, or client(s) 102) in communication with one or more servers 106a-106n (also referred to as server(s) 106) via one or more networks 104, 104a (generally, referred to as network 104 for descriptive purposes—the networks 104 and 104a may be a single network or multiple networks, as understood by those of skill in the art). As will be discussed below, it should be understood that clients 102 include, but are not limited to, such entities as emergency medical service (EMS) providers (e.g., ambulances), hospitals, health care providers (e.g., physicians, nursing homes, clinics, and the like), healthcare companies, emergency service providers (e.g., coast guard, fire departments, police departments and the like) and all other types of companies/entities/healthcare providers that are involved in patient care (e.g., physical therapists). The clients 102 may also be referred to as client nodes or endpoints. In some embodiments, a client 102 has the capacity to function as both a client node seeking access to applications and/or information on a server and as an application server providing access to hosted applications and/or information for other clients 102a-102n. In some embodiments, a client 102 and/or a server 106 communicate via a health data exchange (HDE) system, referred to as HDE 200. In some embodiments, the HDE may be deployed or accessed via any type and/or form of cloud services or systems to provide a cloud-based health data exchange, as discussed in relation to FIGS. 3-3A. Although FIG. 1 shows a network 104 and a network 104a between the clients 102 and the servers 106, the clients 102 and the servers 106 may be on the same network 104. The networks 104 and 104a can be the same type of network or different types of networks. The network 104 and/or the network 104a can be a local-area network (LAN), such as a company Intranet, or a wide area network (WAN), such as the Internet or the World Wide Web. In one embodiment, network 104a may be a private network and network 104 may be a public network. In some embodiments, network 104 may be a private network and network 104a a public network. In another embodiment, networks 104 and 104a may both be private networks.

The network 104 and/or 104a may be any type and/or form of network and may include any of the following: a point to point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network and a wireline network. In some embodiments, the network 104 may comprise a wireless link, such as an infrared channel or satellite band. The network 104 and/or 104a and network topology may be of any such network or network topology as known (or to be known) to those ordinarily skilled in the art capable of supporting the operations described herein.

As shown in FIG. 1, the HDE 200 is shown between the networks 104 and 104a. In some embodiments, the HDE 200 may be located on network 104. In other embodiments, the HDE 200 may be located on network 104a. In yet another embodiment, a plurality of HDE 200 may be deployed on network 104. An HDE 200 may be located at any point in the network or network communications path between a client 102 and a server 106. In yet another embodiment, HDE may be deployed on a third network, and devices such as clients and servers communicate via network 104 or 104a to access the services of the HDE. For example, the HDE may be deployed on a hosted service provider, such as a cloud service provider, and client and servers via a public or private network access the HDE, executing on servers of the cloud service provider.

In some embodiments, the disclosed networks 104 and/or 104a may comprise a content distribution network(s). A “content delivery network” or “content distribution network” (CDN) generally refers to a distributed content delivery system that comprises a collection of computers or computing devices linked by a network or networks. A CDN may employ software, systems, protocols or techniques to facilitate various services, such as storage, caching, communication of content, or streaming media or applications. Services may also make use of ancillary technologies including, but not limited to, “cloud computing,” distributed storage, DNS request handling, provisioning, signal monitoring and reporting, content targeting, personalization, or business intelligence. A CDN may also enable an entity to operate or manage another's site infrastructure, in whole or in part.

An information technology infrastructure may extend from a first network—such as a network owned and managed by an enterprise—into a second network, which may be owned or managed by an entity separate from the entity owning or managing the first network. Resources provided by the second network may be said to be “in a cloud”. Cloud-resident elements may include, without limitation, storage devices, servers, databases and applications. In various embodiments, one or more networks providing computing infrastructure on behalf of customers may be referred to a cloud. In one of these embodiments, a system in which users of a first network access at least a second network including a pool of abstracted, scalable, and managed computing resources capable of hosting user resources may be referred to as a cloud computing environment. In another of these embodiments, resources may include, without limitation, data center resources, applications, and management tools. In some embodiments, Internet-based applications (which may be provided via a “software-as-a-service” or “platform-as a service” model) may be referred to as cloud-based resources.

The HDE and any applications of entities or end users may operate on a plurality of servers. In one embodiment, the system may include multiple, logically-grouped servers 106. In some of these embodiments, the servers 106 may be geographically dispersed. In some cases, the servers may be administered as a single entity. In other embodiments, the servers comprise a plurality of servers. In one embodiment, the servers execute one or more applications on behalf of one or more clients 102. In some embodiments, the servers 106 can be heterogeneous. One or more of the servers 106 can operate according to one type of operating system platform, as discussed above, while one or more of the other servers 106 can operate according to another type of operating system platform (e.g., Unix or Linux). It should be understood that the servers 106 do not need to be physically proximate to another server. Thus, the group of servers 106 logically grouped may be interconnected using a wide-area network (WAN) connection or medium-area network (MAN) connection. For example, server 106a may be physically located in different continents or different regions of a continent, country, state, city, campus, or room from server 106b.

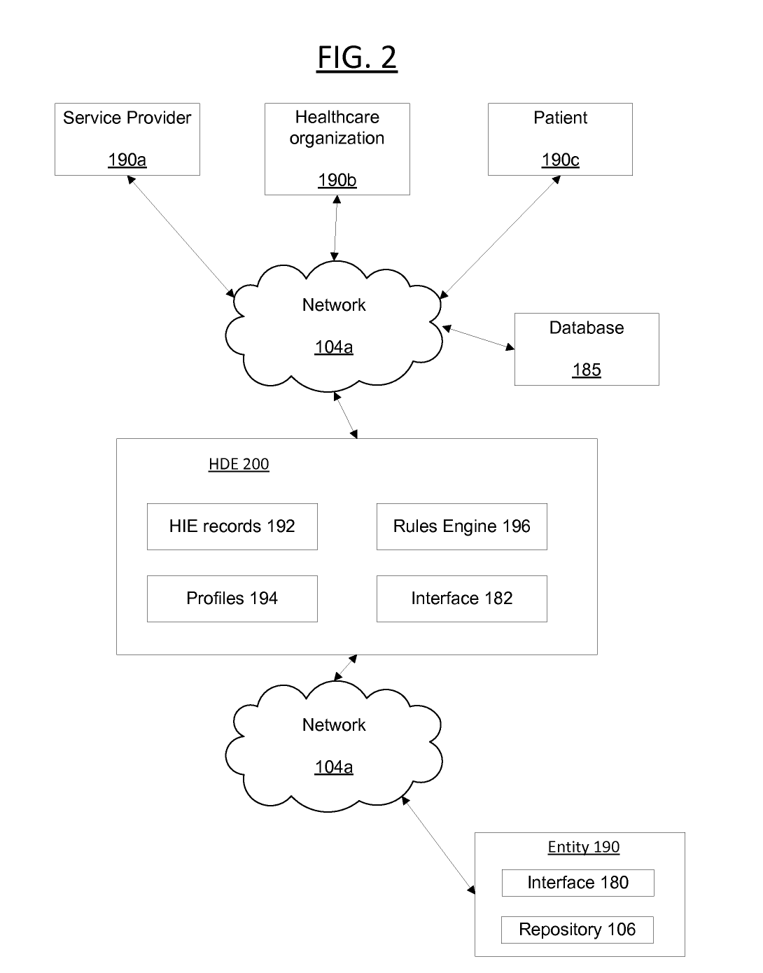

FIG. 2 depicts a health data exchange environment deploying the HDE 200 in accordance with some embodiments. The embodiments discussed herein are in accordance with the preferred embodiments discussed below related to FIG. 3A. As depicted in FIG. 2, a plurality of entities 190a, 190b, 190c′ may be in communication with the HDE 200 via one or more networks 104, 104a. As discussed above, the entities may include healthcare related service providers 190a, healthcare organizations 190b and/or patients 109c. For example, the entity 190-109c, generally referred to as 190, may include or be any type and form of entity. The entity may be a person such as a patient or doctor. The entity may be a service provider, such as any company, organization or group of people who perform one or more services. In the healthcare context, a service provider may be any doctor's office, doctor's practice, clinic, hospital, lab, pharmacy or any other healthcare related provider of services. In some embodiments, the entity may be any type and form of healthcare organization including insurance companies, medical and research organizations and the like. A device, such as a client or server, of the entity may include one or more applications, an interface 180 to the HDE and data repository storing any healthcare related records. In accordance with preferred embodiments, the client device may be located on an ambulance, which is in communication with the HDE, as will be discussed in more detail below. The HDE may have an interface engine to interface with different types and forms of interfaces 180 of entities. While FIG. 2 depicts the patient and service provider entity related to a network which is then related to HDE, in certain instances the providers of electronic records of patient (e.g., ePCR and EMR, and the like) may not necessarily represent a network bringing those entities together, but rather an application solution that may be, but not limited to, a client, web based, or SAAS.

The HDE can store (or access) HIE records 192 to identify patients and the storage of patient medical records externally at any entity 190-190c, such as in the records repository or application of entity 190. According to some embodiments, HIE records can be stored within a Master Patient Index (MPI) within any entity solution discussed herein. The HDE may include profiles 194, such as entity profiles, application profiles and message profiles to perform any of the operations and functionality of the HDE. The HDE may include a rule engine 196 that determines rules for exchanging and transforming information via the exchange.

An entity may execute, operate or otherwise provide an application, which can be any type and/or form of software, program, or executable instructions such as any type and/or form of web browser, web-based client, client-server application, a thin-client computing client, an ActiveX control, or a Java applet, or any other type and/or form of executable instructions capable of executing on a device, such as a client or server. In some embodiments, an application may provide any type and form of healthcare related application or information system. In some embodiments, the application may be a patient registration application. In some embodiments, the application may be an insurance administrative application. In some embodiments, the application may be a healthcare billing system. In some embodiments, the application may be a medical records related application. In some embodiments, the application may be a healthcare practice related application. The application may store one or more records into a records repository, which may be any type and form of database or file system. The application may store and process records in a format understood by the application. The application may store and process records in a format native to the application. The application may process records in one format and store the records in another format. The application may export records from the application or repository into another format, which may be selectable by a user. In accordance with some embodiments of a healthcare related environment, the application may process any type and form of patient records and store such records into the records repository. The application may process any type and form of medical record of a patient and store the medical record into the records repository. The application may process any type and form of medical history information of a patient and store such information into the records repository. In any of these embodiments, the records repository may contain data and information that can be arranged to form a copy of a patient's record or one or more medical records. Such data and information may include doctor's notes, test or lab results and any other written or electronic information associated with the care of a person.

By way of a non-limiting example, each of the entities may have disparate and different applications than other entities. For example, a first entity, a service provider, may store in a first records repository a first medical record of a patient processed or produced by a first application using a first format. A second entity, e.g., an EMS provider, may store in a second records repository a second medical record of a patient processed or produced by a second application using a second format. A plurality of applications and records repositories located at a plurality of different entities may each include different records of the same patient. A plurality of applications and records repositories located at a plurality of different entities may each include some of the same records of the same patient. A plurality of applications and records repositories located at a plurality of different entities may each include a combination of the same and different records of the same patient. As such, in some embodiments, the records of any patient may be distributed disparately across a plurality of entities, applications and/or repositories in different formats. As such, through the systems and methods discussed herein, the HDE 200 can facilitate the communication of such records between entities to enable the efficiency and quality resultant from a continuum of care.

Furthermore, any applications may communicate using any type and form of communication protocols, such as any type and form of healthcare or medical related data formats and protocols. In some embodiments, the first entity storing a first record in a first format may communicate using a first message type or communications protocol while a second entity storing a second record in a second format may communicate using a second message type or communications protocol. As such, in some embodiments, the records of any patient may have to be communicated between entities that support or use different data formats and/or communication protocols.

The entity may execute, deploy or implement any type and form of interface 180 to the HDE. In some embodiments, the interface may be any type and form of executable instructions, including an application, program, script or library. The interface may use any type and form of TCP/IP communications to communicate with the HDE, such as any type of sockets based communications. The interface may use any type and form of folders or directory structure. The interface may run in the background in some embodiments. The interface may be installed seamlessly and transparently to the user. The interface may be transmitted from the HDE to a device of the entity and automatically executed on the device, such as without any installation or interaction by the user.

In some embodiments, the interface may include any type and form of user interface: graphical, command or otherwise. The interface may be a web based user interface to receive input from a user to submit data, information or messages to the HDE and/or receive data, information or messages from the HDE. For example, the interface may comprise a web page for a user to select a name of a patient and query patient information from the HDE. The interface may include executable instructions to send, receive and view documents via the HDE. In some embodiments, the interface may be integrated with, included in or constructed in any of the applications. The interface may include any database interfaces or drivers to access any records repository or application database. The interface may include any application programming interfaces or libraries for accessing any records repository or application database. The interface may include any application programming interfaces for interfacing or communicating with any application.

The HDE may include an interface engine 182. The interface engine may include any type and form of executable instructions executable or executing on a device. The interface engine may comprise an interface corresponding to the interface 180 of an entity. The interface engine may comprise any of the types of interfaces described in connection with interface 180. The interface engine may support and implement a plurality of different types of interfaces. For example, each of the entities 190-109c may have a different type of interface to the HDE but a single interface engine 180 handles and processes communications with each entity's interface.

The interface and/or interface engine may support, implement and communicate using any portion or version of the HL7 Clinical Document Architecture (CDA), which is an XML based markup standard intended to specify the encoding, structure and semantics of clinical documents for exchange. CDA is part of the HL7 version 3 standard, for example. All other existing or to be existing versions are applicable herein Akin to other parts of the HL7 version 3 standard, it was developed using the HL7 development Framework (HDF) and it is based on the HL7 Reference Information Model (RIM) and the HL7 Version 3 Data Types. CDA documents are persistent in nature. The CDA specifies that the content of the document consists of a mandatory textual part (which ensures human interpretation of the document contents) and optional structured parts (for software processing). The structured part relies on coding systems (such as from SNOMED and LOINC) to represent concepts. The CDA standard doesn't specify how the documents should be transported. Documents can be transported using HL7 version 2 messages, HL7 version 3 messages, or any other known or to be known standard or protocol, as well as by other mechanisms, such as, but not limited to, DICOM, MIME attachments to email, http or ftp, and the like. In the U.S., the CDA standard is probably best known as the basis for the Continuity of Care Document (CCD) specification, based on the data model as specified by ASTMs Continuity of Care Record. The U.S. Healthcare Information Technology Standards Panel has selected the CCD as one of its standards. See also HL7 EHRcom Health Informatics Service Architecture (HISA).

The interface and/or interface engine may comprise any version of Java Web Start, which allows users to start software from the network or Internet using a browser. In some embodiments, the HDE and/or interface engine provides the interface to the entity. For example, a user at an entity may login to or access the HDE via a web page. The interface engine may automatically provide and start the interface or portions thereof on the device of the entity. In some embodiments, the browser at the entity may automatically install and/or execute the interface.

In addition to the discussed content delivery system, the HDE 200, via the interface 182, may comprise any peer-to-peer technology for sending and receiving files between devices of entities. The interface may include any technology from BitTorrent to provide peer-to-peer interfaces and communications. The interface may implement any peer-to-peer data or file sharing protocols. In some embodiments, HyperSend provides a peer to peer interface between devices. In some embodiments, the peer-to-peer communications are between a device of one entity and a device of another entity. In some embodiments, the peer-to-peer communications traverse one or more devices of the HDE. In some embodiments, the HDE can establish and/or facilitate the peer-to-peer communications between entities (or nodes).

In accordance with some embodiments, the HDE may generate, process and store records referred to as HIE records. The HDE may identify any data and information regarding a patient from any transmission or exchange of data traversing the HDE. For example, the HDE may identify patient information from unstructured data in Word documents, PDFs, faxes and the like that traverse the HDE. The HDE may identify and form structure to such unstructured data and store the data in a database or repository 192 of the HDE. The HDE may convert various non-structured data, which comprise patient records, to structured data such as in the HL7 standard. The HDE may have a loading or upload or other function that allows an entity to transmit or provide a plurality of records of a plurality of patients to the HDE for creating or pre-populating HIE records. The HDE may store the HIE records in one or more databases of the HDE. These databases may be deployed in a cloud storage system.

The HDE may include one or more profiles 194. The profile may comprise any object, data structure or database data. A profile may be associated with or configured for an entity, an application or a message. A profile may identify one or more characteristics or attributes of the entity, application or message. A profile may be unique to each entity, application or message. In some embodiments, a plurality or collection of profiles may be combined to represent an actual solution or implementation for a given entity, or message depending on system configurations. Profiles can be stacked or combined to form an implementation or solution for an entity, application or message type. The HDE may create or generate a profile for an entity upon registration of the entity with the HDE. The HDE may create or generate a profile for an application based on input from the entity about the application. The HDE may create or generate a profile for a message based on communications via the HDE. The HDE may use any of these profiles in the operations and methods of the HDE.

As discussed above, an entity profile can be comprised within the HDE, which may be referred to as an organization or provider profile, may include any bibliographic or contact information identifying the entity. The entity profile may include any National Provider Identifier (NPI), such as any via the NPI Plan and Provider Enumeration System. The entity profile may include any tax identifier. The entity profile may include any employer or corporate identifier. The entity profile may include any certified system identifier. The entity profile may include any identifier generated by the HDE and assigned to the entity. The entity profile may include identifiers of any entity applications or pointers/identifiers to any application profiles. In some embodiments, the entity profile may include one or more application profiles. An application profile may include any name or identifier of the application. The application profile may identify or specify any file formats supported or used by the application. The application profile may identify or specify any data formats supported or used by the application. The application profile may identify or specify any protocols supported or used by the application. The application profile may identify or specify any versions of file and data formats and/or protocols supported or used by the application. The application profile may identify or specify any HL7 versions and specs accepted. The application profile may identify or specify any custom or proprietary formats. The application profile may identify or specify any national clinical data backbone. The application profile may identify or specify any names and/or codes of the Logical Observation Identifiers Names and Codes (LOINC of loinc.org). The application profile may identify or specify any names and/or codes of SNOMED (Systemized Nomenclature of Medicine-Clinical Terms). The application profile may identify or specify any custom names and/or codes. The application profile may include any certified system identifier.

According to some embodiments, the HDE may include a rules engine 196 to apply any one or more rules to the operations and functionality of the HDE. The rules engine may apply one or more rules to any annotation, transformation, conversion and/or transmission of data, information and messages between entities using the HDE. The rules engine may include any type and form of executable instructions executable or executing on any device. The rules engine may read and understand rules in any predetermined format. The rules or rules engine may be configured by a user of the HDE. The rules may be specified by an entity. The rules may direct, instruct or control the way the HDE communicates, annotates, converts and/or, transforms and/or transmits data, information and messages.

According to some embodiments, the HDE 200 facilitates communications between end points of the HDE system, as illustrated in FIGS. 2-3. FIG. 3A illustrates a preferred network communication protocol within the health data exchange network discussed herein. FIG. 3A illustrates bi-directional dynamic routing of vendor agnostic pre-hospital records. This routing can be to and from electronic media records (EMR), ePCR, electronic health records (EHR) and health information exchange systems (HIE), as discussed above. The HDE system provides a single interaction point for all users (or nodes) on an enhanced network, which allows a user to integrate within the HDE network/platform.

According to some embodiments, in accordance with the above discussion, the Health Data Exchange (HDE) system is designed as a PaaS which enables any compliant pre-hospital software package to connect to any compliant EMR, EHR and/or HIE system. The system provides both dynamic routing across the self service network and stream transformation of content into communication protocols understood by either side. The shared data is used to improve the continuum of care by providing access to the ePCR from within the EMR and/or EHR. As discussed herein, the discussion of ePCR is not limiting, as all types of data representing electronic patient records, such as but not limited to, EMR (electronic medical records), and the like, can be utilized within the scope of the present disclosure. It provides raw data that allows hospitals and others to look at a broader view of patient information starting from the time they called for help rather than the door time at the ER. It can be used to automate submission of data from the pre-hospital record required for registries such as trauma, cardiac, stroke, etc.

As discussed herein, in return for providing information about a patient's care prior to arrival at an emergency department or hospital the EMS provider would like to receive information about how the patient progressed through his shared encounter with the EMS provider and his hospital stay. The data set has been designed to improve pre-hospital patient care through closed loop feedback of patient outcomes post encounter as part of an EMS agency's QA/QI process improvement as a well as improve billing processes through improved payer demographics.

In accordance with some embodiments, the HDE system can act as a concentrator and provider of that information from pre-hospital encounters into a data format that can be consumed and utilized by the greater HIE community. For example, in an embodiment, the HDE employs one or more appropriate associated concentrators to transform transmitted health records into a standard message format for data transfer such as extended meta-language (XML) or Health Level 7 (HL7). In this way, according to some embodiments, the message handling service is an interface to allow for automatic import of health records into centralized patient records at the data store 160 via standard protocols (HL7, XML). For example, suggested data conversion to HL7v3 (United Stated version) or other future versions of HL7 from various other known formats such as HL7v2, Edifact, HL7v3 (United Kingdom Version), HL7v3 (Australian Version), Dicom, X12N, NCPDP.

Currently, when patients are seen in the pre-hospital environment the patient encounter is documented as required by law. This medical/legal record contains information about the present encounter as well as general information about the patient. Some of the information contained within the medical/legal record includes demographic data, run sheets and outcome data. This information can include, but is not limited to: Incident response information, incident location, transport information, incident times, etc.; Patient demographic, injury categorization, physician, living will, insurance information, etc.; Patient medication history, medications and known allergies; The patient's vital signs are recorded to include blood pressure, respiratory rate, pulse, electrocardiogram (ECG), blood glucose, temperature and other relevant clinical findings; All treatments provided to the patient are captured within the record. Findings from the physical assessment of the patient are contained within the medical/legal record. The clinical impression of the person responsible for care is documented along with any pertinent signs and symptoms. A narrative describing the overall incident and any relevant background is contained within the record. In most cases the patient care record used in the pre-hospital environment is capable of collecting over 700 data elements related to the patient encounter.

While most states require electronic communication of this data to their state repositories, the communication between the pre-hospital environment and the rest of healthcare is primarily provided via printed documents. This manual, paper based process increases the chance of human error and the risk of unauthorized disclosure of protected health information (PHI) for both the pre-hospital provider and healthcare entity receiving the patient. Additionally, because there is often a delay in transfer of this information, the clinical staff at the receiving facility may not have access to critical assessment and treatment information found in the pre-hospital patient care record.

HDE resolves two significant gaps in the information exchange process between EMS agencies and emergency departments: HDE automates the transfer of electronic patient records data to receiving facilities, providing both discreet data and digital images of the pre-hospital patient care record. HDE automates the return of patient outcome, patient demographic and other relevant patient information back to pre-hospital care providers from the receiving facility. Patient information returned from the receiving facility will typically contain information about the patient's diagnosis, assessment finding at the hospital, patient demographic and billing information as well as any other data that could be used in a comprehensive QA/QI program. This data enables the pre-hospital agency to quantify the quality of care they provide. Without this information it is impossible for the pre-hospital provider to know whether the care they provided was medically appropriate.

FIG. 3B illustrates a block diagram of an HDE engine for performing the systems and methods discussed herein. The HDE engine 300 includes a receiving engine 302, determining engine 304, patient engine 306, synchronization engine 308, aggregation engine 310, an annotation engine 312 and a transformation engine 314. It should be understood that these engines are non-limiting, in that any engine can be a combination of another engine, and/or additional engines may be involved for processing and communication of the data involved in the systems and methods discussed herein. In some embodiments, the HDE engine may be deployed or accessed via any type and/or form of cloud services, or systems to provide a cloud- based health data exchange, or as a peer-to-peer network, content delivery network, as understood by those of skill in the art. In connection with the discussions of FIGS. 1-3, the HDE engine 300 may be located anywhere on the network. The HDE engine 300 can be located on any device or server. Additionally, in some embodiments, functionality of the HDE engine 300 can be split amongst different networks (or remote networks) and/or multiple devices.

In some embodiments, the HDE engine 300 may be a Dynamic Naming Attribute (DNA) system, may comprise any combination of hardware and software. The HDE engine 300 may comprise an application, program, library, script, process, service, task or any other type and form of executable instructions. The HDE engine 300 may be modular and may be made up of a plurality of components. Each component may comprise executable instructions directed to a set of functionality, logic or operations. The HDE engine 300 may be distributed and deployed and executed on one or more servers. The HDE engine 300 may be distributed and deployed and executed on one or more clients and servers. The HDE may comprise any type and form of web service. The HDE may comprise any type and form of web-based or Internet application. The HDE may comprise any type and form of SaaS or PaaS. The HDE engine 300 may be deployed as an enterprise type application with software installed on one or more devices of an enterprise.

In some embodiments, the HDE engine 300 may comprise any logic, business rules, function and operations to provide an exchange information system, such as in some embodiments, a health data exchange system. The HDE engine 300 may provide a flexible, configurable and efficient system for the identification, transformation and exchange of various information, data and documents between disparate systems and formats. End users of the HDE engine 300 can request, transmit and/or exchange documents, such as patient and medical records, without understanding the underlying technologies necessary to interface, communicate, transform and exchange such information. These end users can work with their native applications and formats and seamlessly and transparently receive documents from different applications and formats from other users.

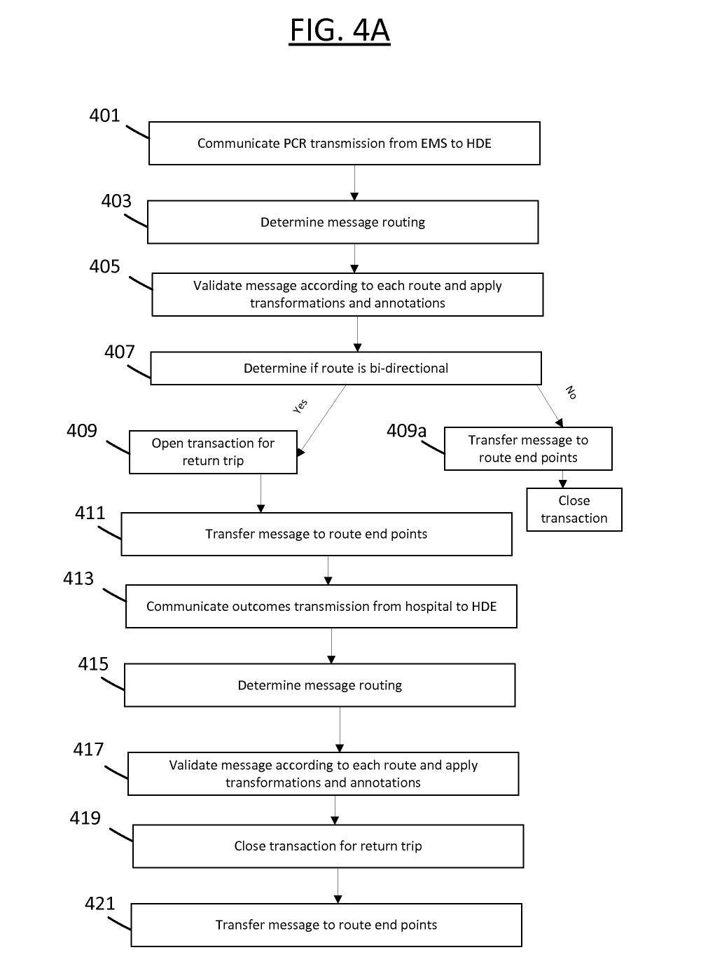

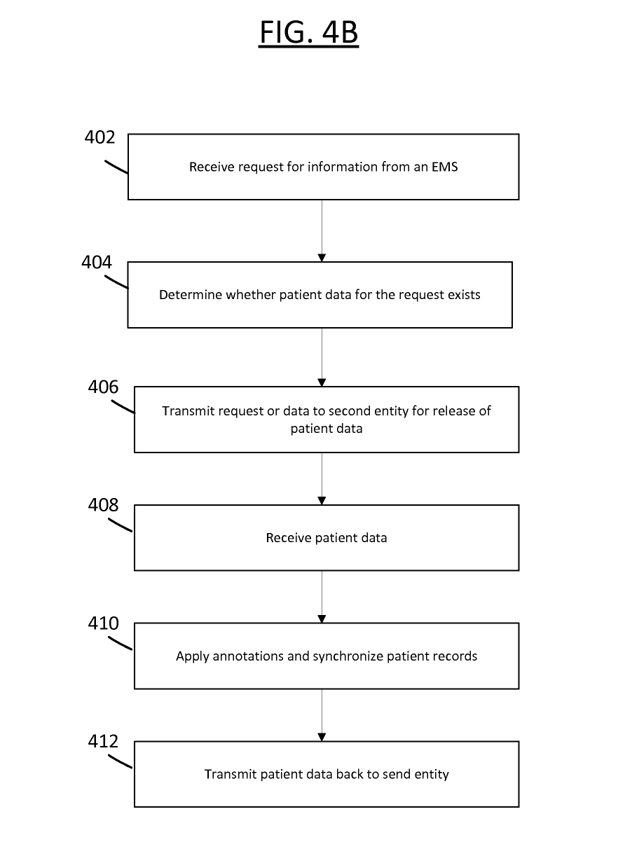

FIGS. 4A-4B each provide a process/flow diagram where instances of the HDE are enabled and utilized to effectuate the continuum of care discussed above. Specific reference will be made to the components of FIG. 3B for illustrative purposes of the functionality and processes performed by the components (or engines) of the HDE engine 300, however they should not be construed to limit the functionality to those specific components of combination of components, as discussed herein. Specifically, FIGS. 4A-4B, illustrate embodiments of steps of a method for exchanging data via a health data exchange system, where there is a real-time exchange of ePCR, EMR, EHR and HIE data between healthcare entities. It should be understood that ePCR, EMR, EHR and HIE data are non-limiting examples of data within the health exchange system discussed herein, as any and all types of data, whether known or to be known, can be transferred, exchanged, retrieved, communicated, modified, transformed, and the like, as discussed herein. Further the type of data should not be construed to limit the scope of disclosure, as, discussed above, any and all types of patient data can be utilized by the disclosed systems and methods. Turning first to FIG. 4A, FIG. 4A illustrates a process for implementing the HDE platform illustrated in FIG. 3A. Specifically, FIG. 4A illustrates preferred embodiments for exchanging data via a HDE where there is a real-time exchange of ePCR, EMR, EHR, HIE data, and the like, between healthcare entities. At step 401, EMS communicates an unsolicited PCR transmission to the HDE. This step is received at the receiving engine 302. As discussed below, the communicating party can be an ambulance, EMS, or pre-hospital service provider to address a patient requiring care. It should be understood that the embodiments discussed herein are related to an ambulance providing care to a patient during the process of tending to the patient while commuting to a hospital; however, it should not be construed to be a limiting case, as information processing and synchronization is and should be readily applicable to all healthcare facilitators, as discussed herein. Furthermore, as discussed in more detail below, it should be understood that the HDE system may receive a request from any type of entity.

In step 403, message routing is determined. That is, according to some embodiments, the determining engine 304 receives or identifies the communication and determines the next processes for the communication, which includes, but is not limited to, determining which profiles to apply. In step 405, the message is validated according to each determined route. Additionally, transformations and annotations are applied to the message, as discussed in more detail below. These steps can be performed via engines 306, 308 and 314, as discussed in more detail below. In step 407, the determination is made whether the route is bi-directional. That is, it is determined if the patient care information discussed herein is applicable and applied from the EMS to the hospital, and from the hospital back to the EMS. If not, the message is transferred to the determined route end points (e.g., hospital), and the transaction is closed. Step 409a. If the route is bi-directional, the transaction involving patient care is opened for a return trip. Step 409, which is performed by engine 308. Thus, in step 411, the message is also transferred to route end points. See engine 308, discussed in more detail below. In some embodiments, the route end points can be a collection of destinations based on stacked routes. In some embodiments, due to the bi-directional nature of the route for the patient, and the information related to and based upon the care given to the patient, the process repeats itself, as illustrated in steps 413-421.

Specifically, in step 413, outcomes from care given at the hospital are communicated from the hospital to the HDE. As in step 403, message routing is determined. Step 415. In step 417, the message involving the outcomes is validated according to the determined route(s), and transformations and annotations are applied. In step 419 the transaction is closed for the return trip, and in step 421 the message is transferred to the determined route endpoints.

FIG. 4B illustrates embodiments involving steps for exchanging data via a HDE where there is a real-time exchange of ePCR, EMR, EHR and HIE data between healthcare entities. It should be understood that specific embodiments, and/or functionality discussed above with relation to FIG. 4A, may be embodied or correlated with those embodiments discussed in relation to FIG. 4B, in that specific steps and their respective discussion for the below steps are also applicable to the above steps from FIG. 4A. Further, preferred and/or alternative embodiments and functionality discussed below are also applicable to FIG. 4A's steps, in that FIG. 4B's steps involving communications, transformations, annotations and the like, and their discussed functionality, capabilities and processes are applicable to the above discussion of such steps and their alternatives in FIG. 4A. At step 402, the health data exchange (HDE) system, as discussed herein receives a request for information of a patient. This can be received at the receiving engine 302. In preferred embodiments, the requesting party is an ambulance or EMS provider who has recently picked up a patient (or ill person(s)) requiring care. During the process of delivering the patient to the hospital, and while caring and attending to the patient, the ambulance is better suited to handle the situation with all the applicable records relevant to the patient's health (or healthcare) data. As such, this information should be readily available to the ambulance via the HDE system, as discussed herein. It should be understood that the embodiments discussed herein are related to an ambulance providing care to a patient during the process of tending to the patient while commuting to a hospital; however, it should not be construed to be a limiting case, as information processing and synchronization is and should be readily applicable to all healthcare facilitators, as discussed herein.

It should be understood that the HDE system may receive a request from any type of entity. The request may include a query for information on the patient accessible via the health data exchange system. The request may comprise a query for a specific type of record of the patient. The request may comprise a request for a medical record of the patient. The request may comprise a request for a particular type of record, such as a particular medical record. The request may comprise a request for a plurality of records of the patient. The request may comprise a request for any or all records of records known by the HDE or otherwise accessible via the HDE. The request may comprise any of the element of a user (e.g. patient or provider) profiles, such as a sending location, receiving location, message type, format and version and acknowledgement requirements. The request may, in some embodiments, be associated with only known patients to the system, referred to as “repeat patients,” or related to all known patients. The HDE system may receive the request via any type of protocol, such as HTTP. The health exchange system may receive the request via socket based or TCP layer connection, or via push/pull from a data repository. Additionally, some embodiments involve an unsolicited receipt of patient information into HDE, as discussed herein.

At step 404, upon receiving the request, the HDE determines whether data for the request exists. This is handled by the determining engine 304. That is, the system determines whether there is existing patient data. In other words, the HDE engine 300 determines whether the patient is a repeat patient. For example, the determination is contingent upon whether there is existing HIE data, or ePCR, EMR, and EHR data. Thus, step 404 involves identifying that a second healthcare entity has a record of a plurality of records of the patient. This can be handled by the patient engine 306, and/or the determining and patient engine 304 and 306, respectively, in correlation with one another. The record is stored by the second healthcare entity in a format identified by a profile of the second healthcare entity. According to some embodiments, HDE determines and identifies via HIE records the entities and patient. The HDE may identify a plurality of entities storing records of the patient externally to the HDE. The HDE may identify another healthcare entity that has a requested record of the patient. The HDE may enumerate the healthcare entities that have records of the patient and organize the enumeration by record types and/or entity types and/or application types. The HDE may identify which entity has a specific record or type of record. The HDE may identify entities having records based on any temporal information. The HDE may identify a plurality of entities that have the same record. The HDE may identify entities with different applications that have the same record. In accordance with some embodiments, the HDE may query the HIE records stored in an HIE records database to identify HIE records of the patient. The HDE may generate HIE records and populate the HIE database based on processing of data, information and messages exchanged via the HDE. For example, the HDE may parse any office documents or electronic files to identify patients and patient records from structured and/or unstructured data of the document or file. From the exchange between entities, the HDE can identify the source of the record and the application associated with the record. From the HIE records of the patient, the HDE can determine the records that have been identified by the HDE for the patient and the location of the record, such as by entity and/or application.

At step 406, the HDE system transmits a request to the second healthcare entity for release of the patient record. This can be handled by the patient engine 306. In some embodiments, the request may include (or require) a request to release the records of the patient from the entity. The HDE may transmit a request to authorize release or transmission of the patient record from the entity. The HDE may transmit a request for the entity to send, transmit or provide the record. The HDE may send a plurality of requests to a plurality of entities for records of a patient.

As discussed above, steps 404 and 406 involve determining if information is available relevant to a patient, then requesting such data. At step 408, the HDE system receives the record of the patient. In some embodiments, this may require a transformation of the data, as discussed above. Such transformation can occur via the HDE system (e.g., transformation engine 314), the providing entity, or the receiving entity. Thus, the HDE system can transmit the patient record in the transformed format to a first healthcare entity responsive to the request of the first healthcare entity. In some embodiments, the HDE may apply rules for filtering, parsing, scraping, clean-up of data, dealing with unstructured data or addressing particular data and protocols of the second entity or second entity application. In some embodiments, the HDE may apply rules to modify, remove or add any one or more data elements to or from the record. In some embodiments, the HDE may apply rules to convert the data from one model to another model. In some embodiments, the HDE may apply rules to convert the data from one set of codes and/or names to another set of codes/and or names. In some embodiments, the HDE may apply rules to map data items from one data protocol model to data items corresponding to another data protocol model. The HDE may transform the record of the patient from a format of the application of the second entity to a format for the application of the first entity. The HDE may transform the record after applying one or more rules. The HDE may transform the record before applying one or more rules. The HDE may apply one or more rules, transform the record and then apply one or more rules to the transformed record. For example, the HDE may apply one or more export rules to the record from the second entity, transform the record, and apply one or more import rules to the record for the first entity.

According to some embodiments, annotations may be viewed as new encounters and/or as an event. In some embodiments, after receiving the data, patient care is given to the patient which can result in annotations, notes or comments to the patient's records. Step 410. In some embodiments, after receiving the data, patient care can be provided to the patient which can result in annotations, notes, comments or an occurrence of care to the patient's records. These annotations, or additions of data to the patient's record can be uploaded in real-time via the HDE system to the storing entity, or can be subsequently uploaded and transmitted to, for example, a hospital network for continued care of the patient upon transfer of the patient. According to some embodiments, annotations and/or additions of data can be uploaded via a handheld device as discussed herein, as an asynchronous response. The asynchronous response can come in multiple parts to make a whole outcome and billing data set to be returned to the originator in part or accumulated into a whole before transmission depending on configuration. This can be performed by the annotation engine 312 and the synchronization engine 308, respectively. By way of non-limiting example, the process flow involves an ambulance picking up patient Bob, the EMS worker can send a request for retrieval on his/her tablet computer for information relevant to Bob's medical history. Upon the request being transmitted, the HDE system facilitates the real-time communication of Bob's medical history. In some embodiments, this data can be stored and retrieved from an HIE, or from other systems, entities that house ePCR, EMR or EHR data, as discussed above. As discussed in more detail below, the EMS worker, while working on Bob can annotate Bob's medical records to provide information related to the care given to Bob, so that upon arriving at the hospital, the hospital has a real-time, up-to-date, and digital copy of Bob's records which can be readily transferred and updated within the hospital's system. Such types of information provided via annotations can include, but are not limited to: Incident response information, incident location, transport information, incident times, etc.; Patient demographic, injury categorization, physician, living will, insurance information, etc.; Patient medication history, medications and known allergies; vital signs, including, but not limited to, blood pressure, respiratory rate, pulse, electrocardiogram (ECG), blood glucose, temperature and other relevant clinical findings; all treatments provided to the patient are captured within the record; pertinent signs and symptoms, and a narrative describing the overall incident and any relevant background.

In step 412, during and/or after caring for the patient at the hospital, the hospital can then provide updates to the patient records, including annotations or other types of data entry relevant to the care given, similar to the above types of data. The updates can be provided via the annotation engine 312, where the data can be aggregated via the aggregation engine 310 and synced via the synchronization engine 308. This data is not only transmitted and synced back up via the HDE system's data provider (e.g., HIE), this data is also communicated to the EMS system. That is, the EMS system receives the updated information from the hospital. This enables the EMS to learn from the care given and readily see and analyze whether the care given to patient was not only applicable, but also assisted in the stabilization and ultimate care of the patient. In some embodiment, the information is not only uploaded back to the housing servers, the information is pushed to the EMS providers. In some embodiments, the information may be uploaded back to the housing servers as well as the originating EMS provider service.

In accordance with some embodiments, for communications to and from any entity within the HDE platform, the HDE may check for and provide any reliability of delivery of transmission of requests and/or records. The HDE may perform or check for any confirmation or acknowledgement of receipt of any requests and/or responses. The HDE may perform or check for any confirmation or acknowledgement of receipt of transmission of a patient record.

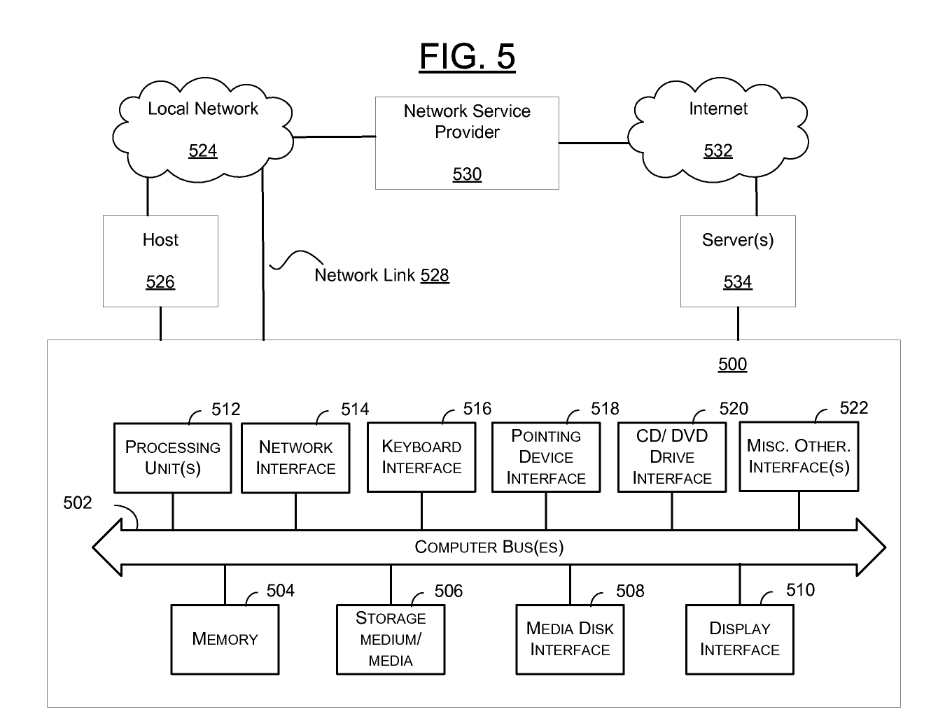

FIG. 5 is a block diagram illustrating an internal architecture of a computing device, e.g., a computing device such as server or user computing device, in accordance with one or more embodiments of the present disclosure. FIG. 5 illustrates a computer system upon which some exemplary embodiments of the present disclosure may be implemented. Although computer system 500 is depicted with respect to a particular device or equipment, it is contemplated that other devices or equipment (e.g., network elements, servers, processors) within can deploy the illustrated hardware and components of system 500.

As shown in FIG. 5, internal architecture 500 includes one or more processing units, processors, or processing cores, (also referred to herein as CPUs) 512, which interface with at least one computer bus 502. Also interfacing with computer bus 502 are computer-readable medium, or media, 506, network interface 514, memory 504, e.g., random access memory (RAM), run-time transient memory, read only memory (ROM), media disk drive interface 520 as an interface for a drive that can read and/or write to media including removable media such as floppy, CD-ROM, DVD, media, display interface 510 as interface for a monitor or other display device, keyboard interface 516 as interface for a keyboard, pointing device interface 518 as an interface for a mouse or other pointing device, and miscellaneous other interfaces not shown individually, such as parallel and serial port interfaces and a universal serial bus (USB) interface.

Memory 504 interfaces with computer bus 502 so as to provide information stored in memory 504 to CPU 512 during execution of software programs such as an operating system, application programs, device drivers, and software modules that comprise program code, and/or computer executable process steps, incorporating functionality described herein, e.g., one or more of process flows described herein. CPU 512 first loads computer executable process steps from storage, e.g., memory 504, computer readable storage medium/media 506, removable media drive, and/or other storage device. CPU 512 can then execute the stored process steps in order to execute the loaded computer-executable process steps. Stored data, e.g., data stored by a storage device, can be accessed by CPU 512 during the execution of computer-executable process steps.

Persistent storage, e.g., medium/media 506, can be used to store an operating system and one or more application programs. Persistent storage can also be used to store device drivers, such as one or more of a digital camera driver, monitor driver, printer driver, scanner driver, or other device drivers, web pages, content files, playlists and other files. Persistent storage can further include program modules and data files used to implement one or more embodiments of the present disclosure, e.g., listing selection module(s), targeting information collection module(s), and listing notification module(s), the functionality and use of which in the implementation of the present disclosure are discussed in detail herein.

Network link 528 typically provides information communication using transmission media through one or more networks to other devices that use or process the information. For example, network link 528 may provide a connection through local network 524 to a host computer 526 or to equipment operated by a Network or Internet Service Provider (ISP) 530. ISP equipment in turn provides data communication services through the public, worldwide packet-switching communication network of networks now commonly referred to as the Internet 532.

A computer called a server host 534 connected to the Internet 532 hosts a process that provides a service in response to information received over the Internet 532. For example, server host 534 hosts a process that provides information representing video data for presentation at display 510. It is contemplated that the components of system 500 can be deployed in various configurations within other computer systems, e.g., host and server.

At least some embodiments of the present disclosure are related to the use of computer system 500 for implementing some or all of the techniques described herein. According to one embodiment, those techniques are performed by computer system 500 in response to processing unit 512 executing one or more sequences of one or more processor instructions contained in memory 504. Such instructions, also called computer instructions, software and program code, may be read into memory 504 from another computer-readable medium 506 such as storage device or network link. Execution of the sequences of instructions contained in memory 504 causes processing unit 512 to perform one or more of the method steps described herein. In alternative embodiments, hardware, such as ASIC, may be used in place of or in combination with software. Thus, embodiments of the present disclosure are not limited to any specific combination of hardware and software, unless otherwise explicitly stated herein.

The signals transmitted over network link and other networks through communications interface, carry information to and from computer system 500. Computer system 500 can send and receive information, including program code, through the networks, among others, through network link and communications interface. In an example using the Internet, a server host transmits program code for a particular application, requested by a message sent from computer, through Internet, ISP equipment, local network and communications interface. The received code may be executed by processor 502 as it is received, or may be stored in memory 504 or in storage device or other non-volatile storage for later execution, or both.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

For the purposes of this disclosure the term “user”, “subscriber” or “customer” should be understood to refer to a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method for providing a continuum of information within a health data exchange system, comprising:
receiving, at a computing device over a network, a request from a first entity, said request comprising an unsolicited request for information associated with a patient;
determining, via the computing device, that said information associated with said patient exists on said network, said determination comprising identifying an existence of a user profile for said patient comprising said information, said existence of said user profile based upon a second entity housing said user profile for said patient;
communicating, via the computing device, a request to said second entity for release of said information comprised within said patient user profile, said release request based upon said request from said first entity and said determination of said existence of said user profile;
receiving, at the computing device, a message from said second entity, said message comprising said requested information;
determining, via the computing device, a route associated with a starting point and an ending point, said route comprising first patient care provided by the first entity associated with the starting point and second patient care provided by a third entity associated with the ending point;
determining, via the computing device, that said route is bidirectional, said bidirectional route comprising said route and third patient care provided by said first entity;
communicating, via the computing device, said message to said first entity, said communication based upon said route and said determination that the route is bi-directional; and
receiving, at the computing device, a first annotation to said message by said first entity, said first annotation associated with the first patient care, said reception of the first annotation comprising automatically updating said patient user profile information with said first annotation.

2. The method of claim 1, further comprising:
communicating a first updated message to said third entity, said first updated message comprising said updated patient user profile information, said communication occurring automatically upon said updating occurring; and
receiving a second annotation to said first updated message by said third entity, said second annotation associated with the second patient care, said reception of the second annotation comprising automatically updating said updated user profile information with said second annotation.

3. The method of claim 2, further comprising:
communicating a second updated message according to said second annotation to said first entity, wherein said second updated message is utilized by said first entity upon providing the third patient care.

4. The method of claim 3, wherein said information in said second entity is synchronized in near-real time based upon said first and second updating associated with the first patient care and the second patient care.

5. The method of claim 1, wherein said information stored in said user profile associated with said patient is stored by said second entity in a second format dictated by said second entity.

6. The method of claim 5, wherein said receiving said information further comprising:
transforming said information into a first format, said first format set by said first entity, said transformation comprising modifying a structure of said information from a second model associated with said second format to a first model associated with said first format;
facilitating exporting said transformed information from said second entity to said first entity in accordance with said message; and
facilitating importing said transformed information to said first entity in accordance with said message, said importation comprising applying import rules set by said first entity.

7. The method of claim 1, wherein said starting point comprising a location associated with an initial interaction between the first entity and the patient, and said ending point comprising a location associated with an initial interaction between the third entity and the patient.

8. The method of claim 7, wherein said third entity is a health care provider.

9. The method of claim 1, further comprising:
determining that said route is not bi-directional; and
communicating said message to said third entity, said communication based upon said route and a determination that the route is not bi-directional.

10. The method of claim 1, wherein said second entity is associated with a second user device, said second entity selected from a group consisting of a pre-hospital service provider, healthcare company, doctor, emergency service provider, and emergency medical service (EMS) agency and provider, said second entity storing said user profile for said patient in a data repository associated with said second entity.

11. The method of claim 1, wherein said information comprises an electronic record of the patient, said electronic record associated with pre-hospital information associated with said patient.

12. The method of claim 1, wherein said first entity is associated with a first user device, said first entity selected from a group consisting of an ambulance, emergency service provider, emergency medical service (EMS) agency and provider, pre-hospital service provider, and a healthcare company .

13. A computer-readable storage medium tangibly encoded with computer-executable instructions, that when executed by a processor associated with a computing device, performs a method comprising:
receiving a request from a first entity, said request comprising an unsolicited request for information associated with a patient;
determining that said information associated with said patient exists on said network, said determination comprising identifying an existence of a user profile for said patient comprising said information, said existence of said user profile based upon a second entity housing said user profile for said patient;
communicating a request to said second entity for release of said information comprised within said patient user profile, said release request based upon said request from said first entity and said determination of said existence of said user profile;
receiving a message from said second entity, said message comprising said requested information;
determining a route associated with a starting point and an ending point, said route comprising first patient care provided by the first entity associated with the starting point and second patient care provided by a third entity associated with the ending point;
determining that said route is bidirectional, said bidirectional route comprising said route and third patient care provided by said first entity;
communicating said message to said first entity, said communication based upon said route and said determination that the route is bi-directional; and
receiving a first annotation to said message by said first entity, said first annotation associated with the first patient care, said reception of the first annotation comprising automatically updating said patient user profile information with said first annotation.

14. The computer-readable storage medium of claim 13, further comprising communicating a first updated message to said third entity, said first updated message comprising said updated patient user profile information, said communication occurring automatically upon said updating occurring; and
receiving a second annotation to said first updated message by said third entity, said second annotation associated with the second patient care, said reception of the second annotation comprising automatically updating said updated user profile information with said second annotation.

15. The computer-readable storage medium of claim 14, further comprising:
communicating a second updated message according to said second annotation to said first entity, wherein said second updated message is utilized by said first entity upon providing the third patient care, wherein said information in said second entity is synchronized in near-real time based upon said first and second updating associated with the first patient care and the second patient care.

16. The computer-readable storage medium of claim 13, wherein said information stored in said user profile associated with said patient is stored by said second entity in a second format dictated by said second entity, and wherein said receiving said information further comprising:
transforming said information into a first format, said first format set by said first entity, said transformation comprising modifying a structure of said information from a second model associated with said second format to a first model associated with said first format;
facilitating exporting said transformed information from said second entity to said first entity in accordance with said message; and
facilitating importing said transformed information to said first entity in accordance with said message, said importation comprising applying import rules set by said first entity.

17. The computer-readable storage medium of claim 13, further comprising:
determining that said route is not bi-directional; and
communicating said message to said third entity, said communication based upon said route and a determination that the route is not bi-directional.

18. A system comprising:
at least one computing device comprising:
memory storing computer-executable instructions; and
one or more processors for executing said computer-executable instructions, comprising:
receiving a request from a first entity, said request comprising an unsolicited request for information associated with a patient;
determining that said information associated with said patient exists on said network, said determination comprising identifying an existence of a user profile for said patient comprising said information, said existence of said user profile based upon a second entity housing said user profile for said patient;
communicating a request to said second entity for release of said information comprised within said patient user profile, said release request based upon said request from said first entity and said determination of said existence of said user profile;
receiving a message from said second entity, said message comprising said requested information;
determining a route associated with a starting point and an ending point, said route comprising first patient care provided by the first entity associated with the starting point and second patient care provided by a third entity associated with the ending point;
determining that said route is bidirectional, said bidirectional route comprising said route and third patient care provided by said first entity;
communicating said message to said first entity, said communication based upon said route and said determination that the route is bi-directional; and
receiving a first annotation to said message by said first entity, said first annotation associated with the first patient care, said reception of the first annotation comprising automatically updating said patient user profile information with said first annotation.

19. The system of claim 18, further comprising:
communicating a first updated message to said third entity, said first updated message comprising said updated patient user profile information, said communication occurring automatically upon said updating occurring;
receiving a second annotation to said first updated message by said third entity, said second annotation associated with the second patient care, said reception of the second annotation comprising automatically updating said updated user profile information with said second annotation; and
communicating a second updated message according to said second annotation to said first entity, wherein said second updated message is utilized by said first entity upon providing the third patient care, wherein said information in said second entity is synchronized in near-real time based upon said first and second updating associated with the first patient care and the second patient care

20. The system of claim 18, further comprising:
determining that said route is not bi-directional; and
communicating said message only to said third entity, said communication based upon said route and a determination that the route is not bi-directional.
